(19) United States
(12) Patent Application Publication
(10) Pub. No.: US 2026/0080255 A1
(43) Pub. Date: Mar. 19, 2026

(54) METHOD AND APPARATUS FOR DETERMINING NEURAL NETWORK MODEL STRUCTURE, DEVICE, MEDIUM AND PRODUCT

(71) Applicant: Beijing Zitiao Network Technology Co., Ltd., Haidian District, Beijing (CN)

(72) Inventors: Xing Wang, Beijing (CN); Wei Li, Beijing (CN); Xin Xia, Beijing (CN); Xuefeng Xiao, Beijing (CN)

(21) Appl. No.: 18/878,292

(22) PCT Filed: Jul. 3, 2023
(86) PCT No.: PCT/CN2023/105495

§ 371 Date: Dec. 23, 2024

(30) Foreign Application Priority Data
Jul. 14, 2022 (CN) 202210832510.X

(51) Int. Cl. G06N 3/092; G06N 3/086

(52) U.S. Cl. CPC G06N 3/092; G06N 3/086

(57) ABSTRACT

The embodiments of the present disclosure provide a neural network model structure determining method and apparatus, a device, a medium and a product. The neural network model structure determining method includes: determining, based on a preset neural network model architecture search algorithm, at least one candidate neural network model; predicting, based on a preset Central Processing Unit (CPU) utilization prediction model, a runtime CPU utilization for each candidate neural network model, so as to obtain a predicted value of CPU utilization; and determining, based on at least one predicted value of CPU utilization, a target neural network model structure among structures of the at least one candidate neural network model.

### STRUCTURE, DEVICE, MEDIUM, AND PRODUCT

The present disclosure claims the priority from the CN patent application No. 202210832510.X filed with the China National Intellectual Property Administration (CNIPA) on Jul. 14, 2022, the content of which is hereby incorporated by reference in its entirety.

### FIELD

Embodiments of the present disclosure generally relate to the technical field of artificial intelligence, and more specifically, to a method, an apparatus, a device, a medium and a product for determining neural network model structure.

### BACKGROUND

In the field of deep learning, there exists a plurality of neural network structures determined through automatic search algorithms. However, due to a large scale, network architecture, or the like, most of the neural network models bring about a series of resource consumption problems after being deployed. For example, a high Central Processing Unit (CPU) utilization may restrict the actual application of the model. Therefore, when a neural network model structure is designed, multiple indicators of the final model after being deployed in practice should be taken into consideration, in addition to the final performance of the network.

Parameters of a neural network model, such as size, computing amount, latency, and the like, are considered in combination with the network performance, to conduct an automatic neural architecture search, and certain achievements have been attained by doing so. However, the CPU utilization during the actual operation of models is neglected in the model searching process. In the case, some models incur high CPU utilizations and high computing resource consumption during actual operation.

### SUMMARY

Embodiments of the present disclosure provide a neural network model structure determining method and apparatus, a device, a medium and a product, to obtain a neural network model structure with a runtime CPU utilization meeting a preset requirement, which can reduce resource consumption of the neural network during operation.

In a first aspect, the present disclosure provides a method of determining a neural network model structure, comprising:
determining, based on a preset neural network model architecture search algorithm, at least one candidate neural network model;
predicting, based on a preset Central Processing Unit (CPU) utilization prediction model, a runtime CPU utilization for each candidate neural network model, so as to obtain a predicted value of CPU utilization; and
determining, based on at least one predicted value of CPU utilization, a target neural network model structure among structures of the at least one candidate neural network model.

In a second aspect, the present disclosure further provides an apparatus for determining a neural network model structure, comprising:
a candidate model determining model configured to determine, based on a preset neural network model architecture search algorithm, at least one candidate neural network model;
a Central Processing Unit (CPU) utilization prediction model configured to predict, based on a preset CPU utilization prediction model, a runtime CPU utilization for each candidate neural network model, so as to obtain a predicted value of CPU utilization; and
a target model structure determining model configured to determine, based on at least one predicted value of CPU utilization, a target neural network model structure among structures of the at least one candidate neural network model.

In a third aspect, the present disclosure further provides an electronic device, comprising:
one or more processors; and
a memory configured to store one or more programs;
wherein the one or more programs, when executed by the one or more processors, cause the one or more processors to implement the method of determining a neural network model structure of any of embodiments of the present disclosure.

In a fourth aspect, the present disclosure further provides a storage medium having computer executable programs stored thereon, wherein the computer executable programs, when executed by a computer processor, implement the method of determining a neural network model structure, as described above.

In a fifth aspect, the present disclosure further provides a computer program product, comprising computer programs which, when executed by a processor, implement the method of determining a neural network model structure, as described above.

### BRIEF DESCRIPTION OF THE DRAWINGS

FIG. 1 illustrates a flowchart of a method of determining a neural network model structure provided by embodiments of the present disclosure;

FIG. 2 illustrates a flowchart of a further method of determining a neural network model structure provided by embodiments of the present disclosure;

FIG. 3 illustrates a schematic diagram of an apparatus for determining a neural network model structure provided by embodiments of the present disclosure; and

FIG. 4 illustrates a schematic diagram of a structure of an electronic device provided by embodiments of the present disclosure.

### DETAILED DESCRIPTION OF EMBODIMENTS

Reference now will be made to the drawings to describe in detail the embodiments of the present disclosure. Although the drawings illustrate some embodiments of the present disclosure, the present disclosure can be implemented in various forms, and those embodiments are provided for an understanding of the present disclosure. The drawings and embodiments of the present disclosure are provided exemplarily.

Respective steps in the implementations of the method according to the present disclosure may be performed in different orders and/or performed in parallel. In addition, the method implementations may include additional steps and/or omit steps included herein. The scope of the present disclosure is not limited thereto.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

The terms “first,” “second” and the like mentioned in the present disclosure are only used to distinguish different apparatuses, modules or units, rather than limit an order of functions performed by the apparatus, module or unit or limit interdependence.

The terms “one” and “a plurality of” mentioned in the present disclosure are illustrative, not restrictive, and should be understood as “one or more” by those skilled in the art, unless explicitly specified otherwise in the context.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers, or storage media that perform operations of the technical solution of the present disclosure.

As an implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, without constituting any limitation to the implementations of the present disclosure. Other methods compliant with the provisions of the relevant laws and regulations can also be applied to the implementations of the present disclosure.

The data (including data per se, and acquisition or application of the data) involved in the present technical solution should comply with the provisions of the relevant laws and regulations.

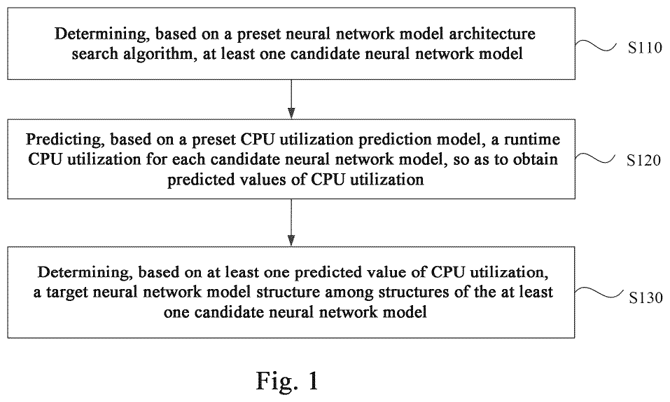

FIG. 1 is a flowchart of a method of determining a neural network model structure provided by embodiments of the present disclosure. The embodiments of the present disclosure can be applied to a scenario of determining a model structure through a neural network architecture search. The method can be performed by an apparatus for determining a neural network model structure, which can be implemented in the form of software and/or software, or by an electronic device that may be a mobile terminal, a Personal Computer (PC) or server, or the like.

As shown therein, the method of determining a neural network model structure includes:
S110: determining, based on a preset neural network model architecture search algorithm, at least one candidate neural network model.

In the field of machine learning, an effect of a machine learning algorithm depends largely on multiple hyperparameters. The hyperparameters are mainly divided into three types, including: a first type of optimization parameters, for example, a learning rate, a batch size, a weight decay, and the like; a second type of parameters that define a network structure, for example, a number of layers of the network, a type of operators in each layer, a filter size in convolution, and the like; and a third type of regularization coefficient. The Neural Architecture Search (NAS), which is a process of automatically adjusting and optimizing parameters of a network structure, can solve the optimal parameter search problem in a high-dimensional space.

Determining, based on a preset neural network model architecture search algorithm, at least one candidate neural network model includes, according to a search strategy corresponding to the preset neural network model architecture search algorithm, searching a preset search space for candidate neural network models that meet requirements of the search strategy.

The preset neural network model architecture search algorithm may be one or more of an evolutionary search algorithm, a random search algorithm, a reinforcement learning algorithm, a gradient optimization algorithm, or a Bayesian search algorithm.

In an implementation, the model architecture search algorithm (strategy) can be optimized through the evolutionary search algorithm, the random search algorithm, the reinforcement learning algorithm, the gradient optimization algorithm or the Bayesian search algorithm, and the candidate neural network models are retrieved according to the optimized search strategy.

S120: predicting, based on a preset CPU utilization prediction model, a runtime CPU utilization for each candidate neural network model, so as to obtain a predicted value of CPU utilization.

Subsequent to determining the candidate neural network models, this step is a process of evaluating the performance of the candidate neural network models. In the present embodiment, priority is given to runtime CPU utilizations of the candidate neural network models, i.e., the computing resource consumption of models during deployment and application is taken into consideration, to prevent the model obtained through training from being restricted in use due to excessive runtime resource consumption.

In the present embodiment, a preset CPU utilization prediction model is used to predict a runtime CPU utilization for each candidate neural network model. The preset CPU utilization prediction model is a pre-trained learning model, which can be encoded according to the input model architecture, and can obtain a prediction result of a CPU utilization accordingly. Upon retrieving each candidate neural network model, the CPU utilization of the candidate neural network model is predicted; or, after a plurality of candidate neural network models is obtained through a search, the CPU utilizations are predicted respectively.

S130: determining, based on at least one predicted value of CPU utilization, a target neural network model structure among structures of the at least one candidate neural network model.

After determining the CPU utilization of each candidate neural network model, a target neural network model meeting the requirement can be filtered out according to the preset CPU utilization requirement.

The predicted value of the CPU utilization obtained in the previous step is compared with a preset CPU utilization threshold; when the predicted value of the CPU utilization is less than the preset CPU utilization threshold, the structure of the candidate neural network model corresponding to the predicted value of the CPU utilization is determined as the target neural network model structure.

The number of the candidate network models may be one or more, and the number of the candidate neural network models meeting the preset CPU utilization requirement may be correspondingly one or more. When the number of candidate neural network models meeting the preset CPU utilization requirement may be greater than 1, a target neural network model structure can be filtered out based on a parameter of the neural network model such as a computing amount, a latency, a model size, network performance, or the like. Further, the retrieved target neural network model architecture can be trained, to obtain a final application model which will be tested and put in use.

In an implementation, on the basis of the filtered target neural network model structure, a preset model structure optimization algorithm such as a pruning algorithm, a quantization algorithm, or the like, may be used to optimize the target neural network model structure, to implement model optimization and improve the model learning efficiency.

The technical solution according to the embodiments of the present disclosure includes: determining, based on a preset neural network model architecture search algorithm, at least one candidate neural network model; predicting a runtime CPU utilization for each candidate neural network model using a preset CPU utilization prediction model, so as to obtain a predicted value of CPU utilization; and determining, based on at least one predicted value of CPU utilization, a target neural network model structure among structures of the at least one candidate neural network model, i.e., with the CPU utilization as a strong constraint, selecting a structure of a neural network model meeting the CPU utilization requirement as a target neural network model structure. The technical solution according to the embodiments of the present disclosure can solve the problem that the model structure obtained through neural architecture search incurs a high runtime CPU utilization and is limited in use, i.e., the technical solution according to the embodiments of the present disclosure can make the CPU utilization for the model structure obtained through neural architecture search meet the requirement, and reduce the runtime resource consumption of the neural network, to facilitate actual deployment and application.

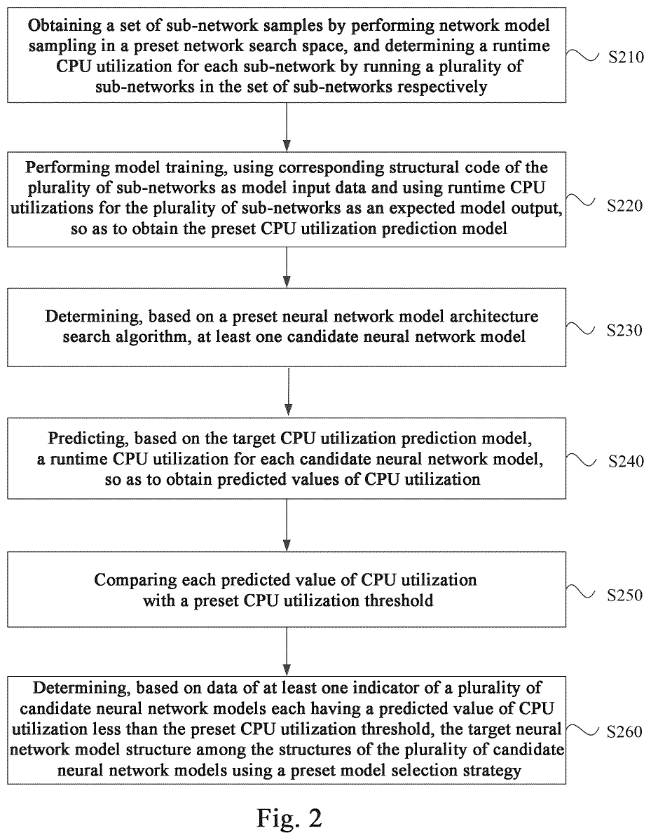

FIG. 2 is a flowchart of a further method of determining a neural network model structure provided by embodiments of the present disclosure, where a process of implementing the method depicts a process from training a CPU utilization prediction model to searching for a model architecture based on the CPU utilization. The method can be performed by a model training apparatus which can be implemented in the form of software and/or hardware, or by an electronic device that may be a mobile terminal, a PC or server, or the like.

As shown therein, the method for determining a neural network model structure includes:
S210: obtaining a set of sub-network samples by performing network model sampling in a preset network search space, and determining a runtime CPU utilization for each sub-network by running a plurality of sub-networks in the set of sub-networks samples respectively.

The preset network search space may be a supernetwork space which includes therein model sub-networks of various structural types. By way of example, a certain number of sub-network architectures, for example, 1000 to 4000, may be sampled, to obtain a set of sub-network samples.

A plurality of sub-networks in the set of sub-network samples can be one-hot encoded, to represent sub-network architecture information in the encoded form, and therefore, the plurality of sub-networks can be differentiated based on the encoding result. Then, each sub-network in the set of sub-network samples is run respectively in the actual operation environment, to test a runtime CPU utilization for each sub-network. Based on the CPU utilization test result, the encoding result and a corresponding CPU utilization test result for each sub-network can form a sample pair, and a dataset is built accordingly for training the CPU utilization prediction model.

S220: performing model training, using corresponding structural code of the plurality of sub-networks as model input data and using runtime CPU utilizations for the plurality of sub-networks as an expected model output, so as to obtain the preset CPU utilization prediction model.

In the step, the sample data obtained in the previous step is used for model training, and when the training rounds reach a preset count and the loss function of the model converges, a corresponding training result, i.e., a target CPU utilization prediction model, can be obtained.

S230: determining, based on a preset neural network model architecture search algorithm, at least one candidate neural network model.

S240: predicting, based on the target CPU utilization prediction model, a runtime CPU utilization for each candidate neural network model, so as to obtain a predicted value of CPU utilization.

S250: comparing each predicted value of CPU utilization with a preset CPU utilization threshold.

S260: determining, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

In general, by setting a neural network model architecture search algorithm, a plurality of candidate neural network models can be obtained, and the number of candidate neural network models meeting a preset CPU utilization threshold requirement is greater than 1. In the case of meeting the CPU utilization constraint, an optimal target neural network model structure can be selected according to constraints on a computing amount, a parameter quantity, and other indicators. For example, based on data of one or more indicators from a computing amount, a model size, and a model latency of a plurality of candidate neural network models each having a predicted value of the CPU utilization less than the preset CPU utilization threshold, a target neural network model structure is determined from the structures of the plurality of candidate neural network models using a Pareto optimal strategy or other optimal solution strategy.

In an application instance, for a target object image segmentation task, the method of determining a neural network model structure according to the embodiments described herein is used to search for a target network models. In the case of the same performance level, as compared with the artificially designed network for the target object image segmentation task, the target network model optimized through the pruning algorithm requires reduced floating point operations (FLOPs) by 20% to25%, and a reduced CPU utilization by 1.5% to 2%.

The technical solution according to the embodiments of the present disclosure includes: building a set of sub-networks, testing a runtime CPU utilization for each sub-network in the set of sub-networks, forming a model structure and CPU utilization sample pairs based on the test results, and obtaining a CPU utilization prediction model through training based on the sample pairs; thereafter, in a process of determining a neural network model based on a preset neural network model architecture search algorithm, predicting a runtime CPU utilization for each candidate neural network model using the obtained CPU utilization prediction model, to obtain a predicted value of the corresponding CPU utilization; and determining, based on at least one predicted value of CPU utilization, a target neural network model structure among structures of the at least one candidate neural network model, i.e., with the CPU utilization as a strong constraint, selecting a structure of a neural network model meeting the CPU utilization requirement as a target neural network model structure. The technical solution according to the embodiments of the present disclosure can solve the problem that the model structure obtained through neural architecture search incurs a high runtime CPU utilization and is limited in use, i.e., the technical solution according to the embodiments of the present disclosure can make the CPU utilization for the model structure obtained through neural architecture search meet the requirement, and reduce the runtime resource consumption of the neural network during operation, to facilitate actual deployment and application.

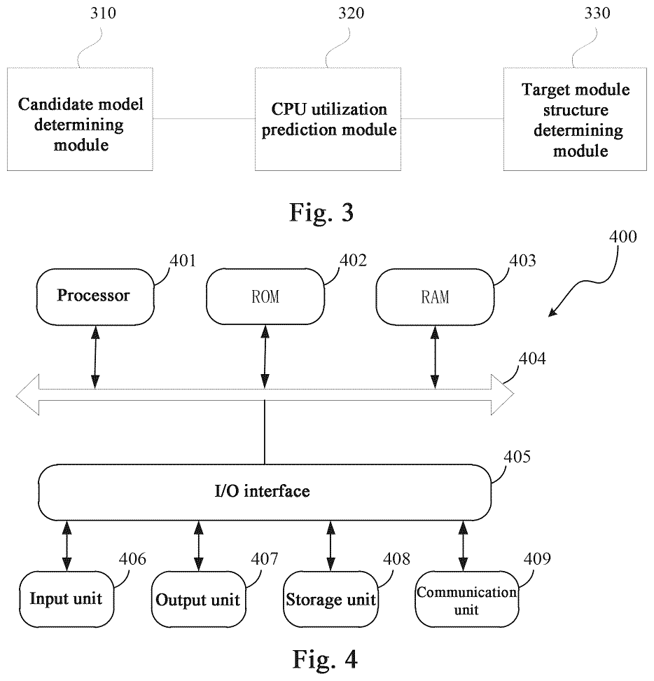

FIG. 3 is a schematic diagram of a structure of an apparatus for determining a neural network model structure, where the apparatus can be applied to a scenario of determining a model structure through neural network architecture search. The apparatus for determining a neural network model structure can be implemented in the form of software and/or hardware, and configured in an electronic device that may be a mobile terminal, a PC or server, or the like.

As shown therein, the apparatus for determining a neural network model structure includes: a candidate model determining model 310, a CPU utilization prediction model 320, and a target model structure determining model 330.

The candidate model determining model 310 is configured to determine, based on a preset neural network model architecture search algorithm, at least one candidate neural network model; the CPU utilization prediction model 320 is configured to predict, based on a preset CPU utilization prediction model, a runtime CPU utilization for each candidate neural network model, so as to obtain a predicted value of CPU utilization; and the target model structure determining model 330 is configured to determine, based on at least one predicted value of CPU utilization, a target neural network model structure among structures of the at least one candidate neural network model.

The technical solution according to the embodiments of the present disclosure includes: determining at least one neural network model based on a preset neural network model architecture search algorithm; predicting a runtime CPU utilization for each candidate neural network model using the obtained CPU utilization prediction model, to obtain a predicted value of the corresponding CPU utilization; and determining, based on at least one predicted value of CPU utilization, a target neural network model structure among structures of the at least one candidate neural network model, i.e., with the CPU utilization as a strong constraint, selecting a structure of a neural network model meeting the CPU utilization requirement as a target neural network model structure. The technical solution according to the embodiments of the present disclosure can solve the problem that the model structure obtained through neural architecture search incurs a high runtime CPU utilization and is limited in use, i.e., the technical solution according to the embodiments of the present disclosure can make the CPU utilization for the model structure obtained through neural architecture search meet the requirement, and reduce the runtime resource consumption of the neural network, to facilitate actual deployment and application.

On the basis of any of technical solutions according to the embodiments of the present disclosure, the target model structure determining module 310 is configured to:
compare each predicted value of CPU utilization with a preset CPU utilization threshold; and in an event that a predicted value of CPU utilization is less than the preset CPU utilization threshold, determine a candidate neural network model structure corresponding to the predicted value of CPU utilization as the target neural network model structure.

On the basis of any of technical solutions according to the embodiments of the present disclosure, in an event that a number of candidate neural network models each having a predicted value of CPU utilization less than the preset CPU utilization threshold is greater than or equal to 2, the target model structure determining module 330 is further configured to:
determine, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

On the basis of any of technical solutions according to the embodiments of the present disclosure, the target model structure determining module 330 is further configured to:
determine, based on data of at least one indicator of a computing amount, a model size, or a model latency of the plurality of candidate neural network models each having a predicted value of the CPU utilization less than the preset CPU utilization threshold, the target neural network model structure among the structures of the plurality of candidate neural network models using a Pareto optimal strategy.

On the basis of any of technical solutions according to the embodiments of the present disclosure, the neural network model structure determining apparatus further includes a model training module configured to train a preset CPU utilization prediction model, and a training process includes:
obtaining a set of sub-network samples by performing network model sampling in a preset network search space, and determining a runtime CPU utilization for each sub-network by running a plurality of sub-networks in the set of sub-networks samples respectively; and performing model training, using corresponding structural code of the plurality of sub-networks as model input data and using runtime CPU utilizations for the plurality of sub-networks as an expected model output, so as to obtain the preset CPU utilization prediction model.

On the basis of any of technical solutions according to the embodiments of the present disclosure, the neural network model structure determining apparatus further includes a model optimization module configured to:
perform structural optimization on the target neural network model structure using a preset model structure optimization algorithm.

On the basis of any of technical solutions according to the embodiments of the present disclosure, the preset neural network model architecture search algorithm includes:
one or more of an evolutionary search algorithm, a random search algorithm, a reinforcement learning algorithm, a gradient optimization algorithm, or a Bayesian search algorithm.

The apparatus provided by the embodiments of the present disclosure, as described above, can perform the method provided by any of the embodiments of the present disclosure, which includes functional modules corresponding to the method and can achieve the same effects.

The plurality of units and modules included in the apparatus are only divided according to the function logic, which are not confined to the above division as long as they can implement the respective functions. In addition, names of the plurality of functional units are employed only for differentiation from one another, without suggesting any limitation to the protection scope of the embodiments of the present disclosure.

FIG. 4 is a schematic diagram of a structure of an electronic device provided by the embodiments of the present disclosure. Reference now will be made to FIG. 4 that illustrates a structure of an electronic device 400 (e.g. a terminal device or server in FIG. 4) adapted to implement the embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital TV, a desktop computer or the like. The electronic device 400 as shown in FIG. 4 is provided merely as an example, without suggesting any limitation to the functions and the application range of the embodiments of the present disclosure.

As shown therein, the electronic device 400 may include a processor (e.g. a central processor, a graphics processor or the like) 401, which can execute various acts and processing based on programs stored in a Read Only Memory (ROM) 402 or a program loaded from a storage unit 408 to a Random Access Memory (RAM) 403. RAM 403 stores therein various programs and data required for operations of the electronic device 400. The processor 401, the ROM 402 and the RAM 403 are connected to one another via a bus 404. An input/output (I/O) interface 405 is also connected to the bus 404.

Typically, the following units may be connected to the I/O interface 405: an input unit 406 including, for example, a touchscreen, a touch pad, a keyboard, a mouse, a camera, a microphone, an accelerometer, a gyroscope and the like; an output unit 407 including, for example, a Liquid Crystal Display (LCD), a loudspeaker, a vibrator and the like; a storage unit 408 including, for example, a tape, a hard drive and the like; and a communication unit 409. The communication unit 409 can allow wireless or wired communication of the electronic device 400 with other devices to exchange data. Although FIG. 4 shows the electronic device 400 including various units, it would be appreciated that not all of the units as shown are required to be implemented or provided. Alternatively, more or fewer units may be implemented or provided.

According to embodiments of the present disclosure, the processes described above with reference to the flowcharts may be implemented as computer software programs. For example, embodiments of the present disclosure include a computer program product comprising a computer program carried on a computer readable medium, the computer program containing program code for performing the methods as in the flowcharts. In those embodiments, the computer program may be downloaded and installed from a network via the communication unit 409, or may be installed from the storage unit 408, or may be installed from the ROM 402. The computer program, when executed by the processor 401, performs the above-described functions defined in the method according to the embodiments of the present disclosure.

Names of messages or information interacted between a plurality of apparatuses in the embodiments of the present disclosure are illustrative rather than limit the scope of the messages or information.

The electronic device provided by the embodiments of the present disclosure belongs to the same invention conception as the method of determining a neural network model structure provided by the above-mentioned embodiments. For the technical details not exhausted here, see the above-mentioned embodiments, and these embodiments can achieve the same effect as the above-mentioned embodiments.

The embodiments of the present disclosure provide a computer storage medium having a computer program stored thereon, where the program, when executed by a processor, implements the method of determining a neural network model structure provided by the above-mentioned embodiments.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to:
determining, based on a preset neural network model architecture search algorithm, at least one candidate neural network model; predicting, based on a preset Central Processing Unit (CPU) utilization prediction model, a runtime CPU utilization for each candidate neural network model, so as to obtain a predicted value of CPU utilization; and determining, based on at least one predicted value of CPU utilization, a target neural network model structure among structures of the at least one candidate neural network model.

Computer program codes for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the functionality and operation of possible implementations of methods, apparatus and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

The units described in the embodiments of the present disclosure may be implemented by software or hardware. Wherein, the designation of a module or unit does not in some cases constitute a limitation to the unit itself.

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

The embodiments of the present disclosure further provide a computer program product including computer programs, where the computer programs, when executed by a processor, impalement the method of determining a neural network model provided by any of the embodiments of the present disclosure.

In the process of implementing the computer program product, computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a Local Area Network (LAN) and a Wide Area Network (WAN). Alternatively, the remote computer may connect to an external computer (such as achieving internet connection by services provided by the internet network service provider).

According to one or more embodiments of the present disclosure, [Example 1] provides a method of determining a neural network model structure, comprising:
determining, based on a preset neural network model architecture search algorithm, at least one candidate neural network model;
predicting, based on a preset Central Processing Unit (CPU) utilization prediction model, a runtime CPU utilization for each candidate neural network model, so as to obtain a predicted value of CPU utilization; and
determining, based on at least one predicted value of CPU utilization, a target neural network model structure among structures of the at least one candidate neural network model.

According to one or more embodiments of the present disclosure, [Example 2] provides a method of determining a neural network model structure, further comprising:

In some implementations, determining, based on the at least one predicted value of CPU utilization, the target neural network model structure among the structures of the at least one candidate neural network model comprises:
comparing each predicted value of CPU utilization with a preset CPU utilization threshold; and
in an event that a predicted value of CPU utilization is less than the preset CPU utilization threshold, determining a candidate neural network model structure corresponding to the predicted value of CPU utilization as the target neural network model structure.

According to one or more embodiments of the present disclosure, [Example 3] provides a method of determining a neural network model structure, comprising:

In some implementations, in an event that a number of candidate neural network models each having a predicted value of CPU utilization less than the preset CPU utilization threshold is greater than or equal to 2, determining, based on the at least one predicted value of CPU utilization, the target neural network model structure among the structures of the at least candidate one neural network model comprises:
determining, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

According to one or more embodiments of the present disclosure, [Example 4] provides a method of determining a neural network model structure, further comprising:

In some implementations, determining, based on the data of the at least one indicator of the plurality of candidate neural network models each having a predicted value of CPU utilization less than the preset CPU utilization threshold, the target neural network model structure among the structures of the plurality of candidate neural network models using the preset model selection strategy comprises:
determining, based on data of at least one indicator of a computing amount, a model size, or a model latency of the plurality of candidate neural network models each having a predicted value of the CPU utilization less than the preset CPU utilization threshold, the target neural network model structure among the structures of the plurality of candidate neural network models using a Pareto optimal strategy.

According to one or more embodiments of the present disclosure, [Example 5] provides a method of determining a neural network model structure, further comprising:

In some implementations, a training process of the preset CPU utilization prediction model comprises:
obtaining a set of sub-network samples by performing network model sampling in a preset network search space, and determining a runtime CPU utilization for each sub-network by running a plurality of sub-networks in the set of sub-networks samples respectively; and
performing model training, using corresponding structural code of the plurality of sub-networks as model input data and using runtime CPU utilizations for the plurality of sub-networks as an expected model output, so as to obtain the preset CPU utilization prediction model.

According to one or more embodiments of the present disclosure, [Example 6] provides a method of determining a neural network model structure, further comprising:

In some implementations, performing structural optimization on the target neural network model structure using a preset model structure optimization algorithm.

According to one or more embodiments of the present disclosure, [Example 7] provides a method of determining a neural network model structure, further comprising:

In some implementations, the preset neural network model architecture search algorithm comprises:
at least one of an evolutionary search algorithm, a random search algorithm, a reinforcement learning algorithm, a gradient optimization algorithm, or a Bayesian search algorithm.

According to one or more embodiments of the present disclosure, [Example 8] provides an apparatus for determining a neural network model structure, comprising:
a candidate model determining model configured to determine, based on a preset neural network model architecture search algorithm, at least one candidate neural network model;
a CPU utilization prediction model configured to predict, based on a preset CPU utilization prediction model, a runtime CPU utilization for each candidate neural network model, so as to obtain a predicted value of CPU utilization; and
a target model structure determining model configured to determine, based on at least one predicted value of CPU utilization, a target neural network model structure among structures of the at least one candidate neural network model.

According to one or more embodiments of the present disclosure, [Example 9] provides an apparatus for determining a neural network model structure, further comprising:

In some implementations, the target model structure determining module is configured to:
compare each predicted value of CPU utilization with a preset CPU utilization threshold; and
in an event that a predicted value of CPU utilization is less than the preset CPU utilization threshold, determine a candidate neural network model structure corresponding to the predicted value of CPU utilization as the target neural network model structure.

According to one or more embodiments of the present disclosure, [Example 10] provides an apparatus for determining a neural network model structure, comprising:

In some implementations, in an event that a number of candidate neural network models each having a predicted value of CPU utilization less than the preset CPU utilization threshold is greater than or equal to 2, the target model structure determining module is further configured to:
determine, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

According to one or more embodiments of the present disclosure, [Example 11] provides an apparatus for determining a neural network model structure, further comprising:

In some implementations, the target model structure determining module is further configured to:
determine, based on data of at least one indicator of a computing amount, a model size, or a model latency of the plurality of candidate neural network models each having a predicted value of the CPU utilization less than the preset CPU utilization threshold, the target neural network model structure among the structures of the plurality of candidate neural network models using a Pareto optimal strategy.

According to one or more embodiments of the present disclosure, [Example 12] provides an apparatus for determining a neural network model structure, further comprising:

In some implementations, the apparatus for determining a neural network model structure further comprises a model training module configured to training a preset CPU utilization prediction model, and a training process comprising:
obtaining a set of sub-network samples by performing network model sampling in a preset network search space, and determining a runtime CPU utilization for each sub-network by running a plurality of sub-networks in the set of sub-networks samples respectively; and
performing model training, using corresponding structural code of the plurality of sub-networks as model input data and using runtime CPU utilizations for the plurality of sub-networks as an expected model output, so as to obtain the preset CPU utilization prediction model.

According to one or more embodiments of the present disclosure, [Example 13] provides an apparatus for determining a neural network model structure, further comprising:

In some implementations, the apparatus for determining a neural network model structure further comprises a model optimization module configured to:
perform structural optimization on the target neural network model structure using a preset model structure optimization algorithm.

According to one or more embodiments of the present disclosure, [Example 14] provides an apparatus for determining a neural network model structure, further comprising:

In some implementations, the preset neural network model architecture search algorithm comprises:
at least one of an evolutionary search algorithm, a random search algorithm, a reinforcement learning algorithm, a gradient optimization algorithm, or a Bayesian search algorithm.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single implementation may also be implemented in multiple embodiments separately or in any suitable sub-combination.

1. A method of determining a neural network model structure, comprising:
determining, based on a preset neural network model architecture search algorithm, at least one candidate neural network model;
predicting, based on a preset Central Processing Unit (CPU) utilization prediction model, a runtime CPU utilization for each candidate neural network module, so as to obtain a predicted value of CPU utilization; and
determining, based on at least one predicted value of CPU utilization, a target neural network model structure among structures of the at least one candidate neural network model.

2. The method of claim 1, wherein determining, based on the at least one predicted value of CPU utilization, the target neural network model structure among the structures of the at least one candidate neural network model comprises:
comparing each predicted value of CPU utilization with a preset CPU utilization threshold; and
in an event that the predicted value of CPU utilization is less than the preset CPU utilization threshold, determining a candidate neural network model structure corresponding to the predicted value of CPU utilization as the target neural network model structure.

3. The method of claim 2, wherein, in an event that a number of candidate neural network models each having a predicted value of CPU utilization less than the preset CPU utilization threshold is greater than or equal to 2, determining, based on the at least one predicted value of CPU utilization, the target neural network model structure among the structures of the at least candidate one neural network model comprises:
determining, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

4. The method of claim 3, wherein determining, based on the data of the at least one indicator of the plurality of candidate neural network models each having a predicted value of CPU utilization less than the preset CPU utilization threshold, the target neural network model structure among the structures of the plurality of candidate neural network models using the preset model selection strategy comprises:
determining, based on data of at least one indicator of a computing amount, a model size, or a model latency of the plurality of candidate neural network models each having a predicted value of the CPU utilization less than the preset CPU utilization threshold, the target neural network model structure among the structures of the plurality of candidate neural network models using a Pareto optimal strategy.

5. The method of claim 1, wherein a training process of the preset CPU utilization prediction model comprises:
obtaining a set of sub-network samples by performing network model sampling in a preset network search space, and determining a runtime CPU utilization for each sub-network by running a plurality of sub-networks in the set of sub-networks samples respectively; and
performing model training, by using corresponding structural codes of the plurality of sub-networks as model input data and using runtime CPU utilizations for the plurality of sub-networks as an expected model output, so as to obtain the preset CPU utilization prediction model.

6. The method of claim 1, further comprising:
performing structural optimization on the target neural network model structure by using a preset model structure optimization algorithm.

7. The method of claim 1, wherein the preset neural network model architecture search algorithm comprises at least one of an evolutionary search algorithm, a random search algorithm, a reinforcement learning algorithm, a gradient optimization algorithm, or a Bayesian search algorithm.

8. (canceled)

9. An electronic device, comprising:
at least one processor; and
a memory configured to store at least one computer executable instruction;
wherein the at least one computer executable instruction, when executed by the at least one processor, causes the at least one processor to:
determine, based on a preset neural network model architecture search algorithm, at least one candidate neural network model;
predict, based on a preset Central Processing Unit (CPU) utilization prediction model, a runtime CPU utilization for each candidate neural network module, so as to obtain a predicted value of CPU utilization; and
determine, based on at least one predicted value of CPU utilization, a target neural network model structure among structures of the at least one candidate neural network model.

10. (canceled)

11. A computer program product, comprising computer executable instructions stored on a non-transitory computer storage medium which, when executed by a processor, cause the processor to:
determine, based on a preset neural network model architecture search algorithm, at least one candidate neural network model;
predict, based on a preset Central Processing Unit (CPU) utilization prediction model, a runtime CPU utilization for each candidate neural network module, so as to obtain a predicted value of CPU utilization; and
determine, based on at least one predicted value of CPU utilization, a target neural network model structure among structures of the at least one candidate neural network model.

12. The electronic device of claim 9, wherein the instructions to determine, based on the at least one predicted value of CPU utilization, the target neural network model structure among the structures of the at least one candidate neural network model comprises instructions to:
compare each predicted value of CPU utilization with a preset CPU utilization threshold; and
in an event that the predicted value of CPU utilization is less than the preset CPU utilization threshold, determine a candidate neural network model structure corresponding to the predicted value of CPU utilization as the target neural network model structure.

13. The electronic device of claim 12, wherein the instructions to in an event that a number of candidate neural network models each having a predicted value of CPU utilization less than the preset CPU utilization threshold is greater than or equal to 2, determine, based on the at least one predicted value of CPU utilization, the target neural network model structure among the structures of the at least one candidate neural network model comprises instructions to:
determine, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

14. The electronic device of claim 13, wherein the instructions to determine, based on the data of the at least one indicator of the plurality of candidate neural network models each having a predicted value of CPU utilization less than the preset CPU utilization threshold, the target neural network model structure among the structures of the plurality of candidate neural network models using the preset model selection strategy comprises instructions to:
determine, based on data of at least one indicator of a computing amount, a model size, or a model latency of the plurality of candidate neural network models each having a predicted value of the CPU utilization less than the preset CPU utilization threshold, the target neural network model structure among the structures of the plurality of candidate neural network models using a Pareto optimal strategy.

15. The electronic device of claim 9, wherein a training process of the preset CPU utilization prediction model comprises instructions to cause the at least one processor to:
obtain a set of sub-network samples by performing network model sampling in a preset network search space, and determine a runtime CPU utilization for each sub-network by running a plurality of sub-networks in the set of sub-networks samples respectively; and
perform model training, by using corresponding structural codes of the plurality of sub-networks as model input data and using runtime CPU utilizations for the plurality of sub-networks as an expected model output, so as to obtain the preset CPU utilization prediction model.

16. The electronic device of claim 9, wherein the instructions further comprise instructions to cause the at least one processor to:
perform structural optimization on the target neural network model structure by using a preset model structure optimization algorithm.

17. The electronic device of claim 9, wherein the preset neural network model architecture search algorithm comprises:
at least one of an evolutionary search algorithm, a random search algorithm, a reinforcement learning algorithm, a gradient optimization algorithm, or a Bayesian search algorithm.

18. The computer program product of claim 11, wherein the instructions to determine, based on the at least one predicted value of CPU utilization, the target neural network model structure among the structures of the at least one candidate neural network model comprises instructions to:
compare each predicted value of CPU utilization with a preset CPU utilization threshold; and
in an event that the predicted value of CPU utilization is less than the preset CPU utilization threshold, determine a candidate neural network model structure corresponding to the predicted value of CPU utilization as the target neural network model structure.

19. The computer program product of claim 18, wherein the instructions to in an event that a number of candidate neural network models each having a predicted value of CPU utilization less than the preset CPU utilization threshold is greater than or equal to 2, determine, based on the at least one predicted value of CPU utilization, the target neural network model structure among the structures of the at least one candidate neural network model comprises instructions to:
determine, based on data of at least one indicator of a plurality of candidate neural network models each having a predicted value of CPU utilization less than the preset CPU utilization threshold, the target neural network model structure among the structures of the plurality of candidate neural network models using a preset model selection strategy.

20. The computer program product of claim 19, wherein the instructions to determine, based on the data of the at least one indicator of the plurality of candidate neural network models each having a predicted value of CPU utilization less than the preset CPU utilization threshold, the target neural network model structure among the structures of the plurality of candidate neural network models using the preset model selection strategy comprises instructions to:
determine, based on data of at least one indicator of a computing amount, a model size, or a model latency of the plurality of candidate neural network models each having a predicted value of the CPU utilization less than the preset CPU utilization threshold, the target neural network model structure among the structures of the plurality of candidate neural network models using a Pareto optimal strategy.

21. The computer program product of claim 11, wherein a training process of the preset CPU utilization prediction model comprises instructions to cause the at least one processor to:
obtain a set of sub-network samples by performing network model sampling in a preset network search space, and determine a runtime CPU utilization for each sub-network by running a plurality of sub-networks in the set of sub-networks samples respectively; and
perform model training, using corresponding structural codes of the plurality of sub-networks as model input data and using runtime CPU utilizations for the plurality of sub-networks as an expected model output, so as to obtain the preset CPU utilization prediction model.

22. The computer program product of claim 11, wherein the instructions further comprise instructions to cause the at least one processor to:
perform structural optimization on the target neural network model structure by using a preset model structure optimization algorithm.
